(19) United States
(12) Patent Application Publication
(10) Pub. No.: US 2010/0201815 A1
(43) Pub. Date: Aug. 12, 2010

(54) Systems and methods for video monitoring

(75) Inventors: Doug Anderson, Campbell, CA (US); Ryan Case, San Francisco, CA (US); Rob Haitani, Menlo Park, CA (US); Bob Petersen, Santa Clara, CA (US); Greg Shirai, Oakland, CA (US)

Correspondence Address: CARR & FERRELL LLP, 2200 GENG ROAD, PALO ALTO, CA, 94303, US

(73) Assignee: Vitamin D, Inc.

(21) Appl. No.: 12/378,030

(22) Filed: Feb. 9, 2009

(51) Int. Cl. H04N 7/18

(52) U.S. Cl. 348/148; 348/143; 348/E07.085

(57) ABSTRACT

Embodiments of systems and methods for video monitoring are provided. A method for providing video monitoring includes three steps. A target is identified by a computing device and is displayed from a video through a display of the computing device. A selection of a trigger is received via a user input to the computing device. A response of the computing device is provided, based on recognition of the identified target and the selected trigger from the video.

### CROSS-REFERENCE TO RELATED APPLICATIONS

This application is related to the U.S. patent application Ser. No. ______ filed on Feb. 9, 2009, titled “Systems and Methods for Video Analysis,” which is hereby incorporated by reference.

### SUMMARY OF THE INVENTION

Embodiments of systems and methods for video monitoring are provided herein. In a first embodiment, a method for providing video monitoring includes three steps. The first step is the step of identifying a target by a computing device. The target is displayed from a video through a display of the computing device. The second step of the method is the step of receiving a selection of a trigger via a user input to the computing device. The third step of the method is the step of providing a response of the computing device, based on recognition of the identified target and the selected trigger from the video.

In a second embodiment, a computer readable storage medium is described. The computer readable storage medium includes instructions for execution by the processor which causes the processor to provide a response. The processor is coupled to the computer readable storage medium, and the processor executes the instructions on the computer readable storage medium. The processor executes instructions to identify a target by a computing device, where the target is being displayed from a video through a display of the computing device. The processor also executes instructions to receive a selection of a trigger via a user input to the computing device. Further, the processor executes instructions to provide the response of the computing device, based on recognition of the identified target and the selected trigger from the video.

According to a third embodiment, a system for recognizing targets from a video is provided. The system includes a target identification module, an interface module and a response module. The target identification module is configured for identifying a target from the video supplied to a computing device. The interface module is in communication with the target identification module. The interface module is configured for receiving a selection of a trigger based on a user input to the computing device. The response module is in communication with the target identification module and the interface module. The response module is configured for providing a response based on recognition of the identified target and the selected trigger from the video.

According to a fourth embodiment, a system for providing video monitoring is supplied. The system includes a processor and a computer readable storage medium. The computer readable storage medium includes instructions for execution by the processor which causes the processor to provide a response. The processor is coupled to the computer readable storage medium. The processor executes the instructions on the computer readable storage medium to identify a target, receive a selection of a trigger, and provide a response, based on recognition of the identified target and the selected trigger from a video.

### BRIEF DESCRIPTION OF THE DRAWINGS

FIG. 1 is a diagram of an exemplary network environment for a system for providing video monitoring.

FIG. 2 is a flow chart showing an exemplary method of providing video monitoring.

FIG. 3 is a diagram of an exemplary architecture of a system for providing video monitoring.

FIG. 4 is an exemplary screenshot of a display on a computing device interacting with some of the various embodiments disclosed herein.

FIG. 5 is a second exemplary screenshot of a display on a computing device interacting with some of the various embodiments disclosed herein.

FIG. 6 is a third exemplary screenshot of a display on a computing device interacting with some of the various embodiments disclosed herein.

### DETAILED DESCRIPTION OF THE INVENTION

Most video monitoring systems and software programs are difficult to install, utilize and maintain. In other words, most video monitoring systems and programs require a custom (and sometimes expensive) installation by an expert, and they require constant maintenance and fine-tuning because such systems and programs are not equipped to filter certain aspects or images from a video. They are not calibrated with intelligent computing. Furthermore, existing systems and programs are not user-extensible, nor are they user-friendly. That is, existing systems and programs cannot be configured to apply a user's rules or commands that can be applied to a video using easy-to-learn techniques.

The technology presented herein provides embodiments of systems and methods for conducting video monitoring in a user-friendly, user-extensible manner. Systems and methods for providing user-configurable rules in order to search video metadata, for both real-time and archived searches, are provided herein. The technology may be implemented through a variety of means, such as object recognition, artificial intelligence, hierarchical temporal memory (HTM), and any technology that recognizes patterns found in objects. The technology may be implemented through any technology that can establish categories of objects. However, one skilled in the art will recognize that these lists of ways to implement the technology are exemplary and the technology is not limited to a single type of implementation.

The technology presented herein also allows for new objects to be taught or recognized. By allowing for new objects to be recognized, the systems and methods described herein are extensible, flexible, more robust, and not easily fooled by variations. Also, such systems and methods are more tolerant of bad lighting and focus because the technology as implemented operates at a high level of object recognition.

Further, one skilled in the art will recognize that although some embodiments are provided herein for video monitoring, any type of monitoring from any data source may be utilized with this technology. For instance, instead of a video source, an external data source (such as a web-based data source in the form of a news feed) may be provided instead. The technology is flexible to utilize any data source, and is not restricted to only video sources or video streams.

The technology herein may also utilize, manipulate, or display metadata. In some embodiments, the metadata may be associated with a video. For instance, metadata in a video may be useful to define and/or recognize triggered events according to rules that are established by a user. Metadata may also be useful to provide only those videos or video clips that conform to the parameters set by a user through rules. By doing this, videos or video clips that may include triggered events as identified by the user may be provided to the user. Thus, the user is not shown hundreds or thousands of videos, but the user is provided with a much smaller set of videos that meets the user's requirements as set forth in one or more rules.

Also, metadata in video may be searched using user-configurable rules for both real-time and archive searches. As will be described in greater detail herein, metadata in video may be associated with camera, target and/or trigger attributes of a target that is logged for processing, analyzing, reporting and/or data mining methodologies. Metadata may be extracted, filtered, presented, and used as keywords for searches. Metadata in video may also be accessible to external applications. Further discussion regarding the use of metadata in video will be provided herein.

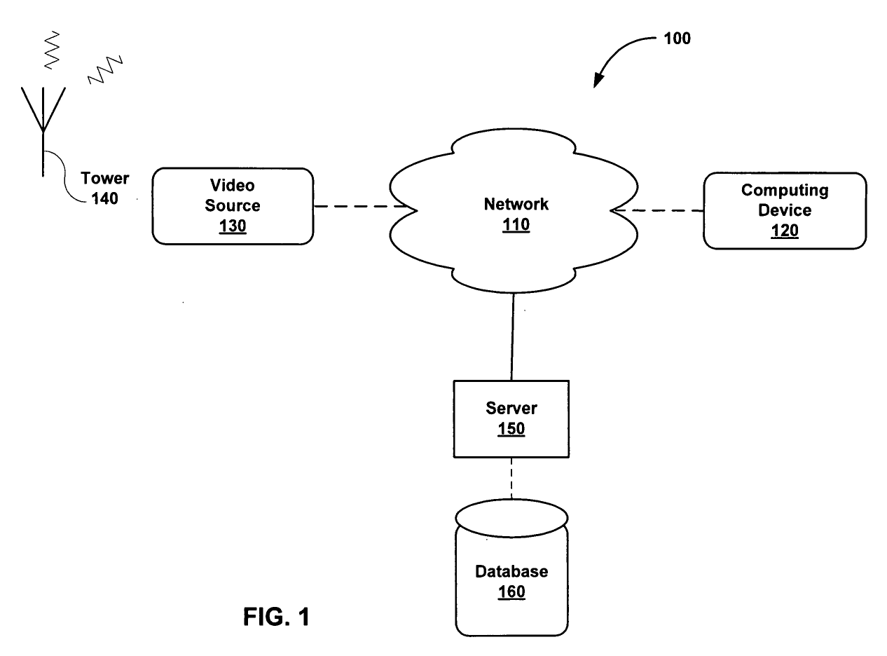

FIG. 1 depicts an exemplary networking environment 100 for a system that provides video monitoring. Like numbered elements in the figures refer to like elements. The exemplary networking environment 100 includes a network 110, one or more computing devices 120, one or more video sources 130, one or more optional towers 140, a server 150, and an optional external database 160. The network 110 may be the Internet, a mobile network, a local area network, a home network, or any combination thereof. The network 110 may be configured to couple with one or more computing devices 120.

The computing device 120 may be a computer, a laptop computer, a desktop computer, a mobile communications device, a personal digital assistant, a video player, an entertainment device, a game console, a GPS device, networked sensor, card key reader, credit card reader, a digital device, a digital computing device and any combination thereof. The computing device 120 preferably includes a display (not shown). One skilled in the art will recognize that a display may include one or more browsers, one or more user interfaces, and any combination thereof. The display of the computing device 120 may be configured to show one or more videos. A video can be a video feed, a video scene, a captured video, a video clip, a video recording, or any combination thereof.

The network 110 may be also configured to couple to one or more video sources 130. The video may be provided by one or more video sources 130, such as a camera, a fixed security camera, a video camera, a video recording device, a mobile video recorder, a webcam, an IP camera, pre-recorded data (e.g., pre-recorded data on a DVD or a CD), previously stored data (including, but not limited to, previously stored data on a database or server), archived data (including but not limited to, video archives or historical data), and any combination thereof. The computing device 120 may be a mobile communications device that is configured to receive and transmit signals via one or more optional towers 140.

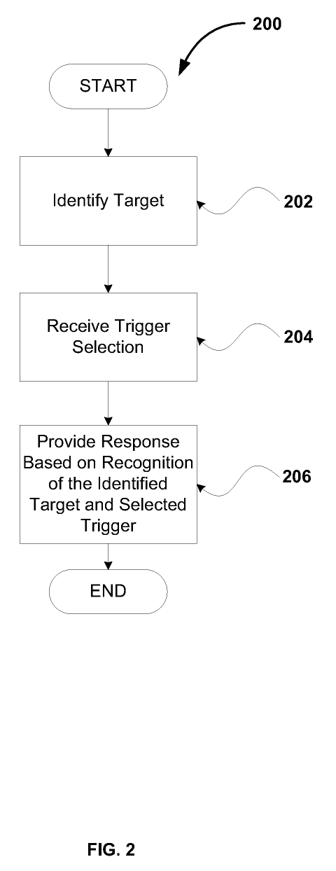

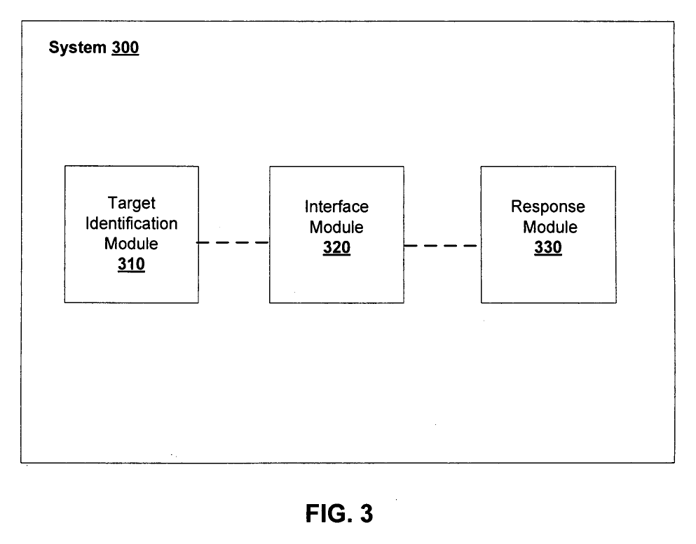

Still referring to FIG. 1, the network 110 may be configured to couple to the server 150. As will be described herein, the server 150 may use one or more exemplary methods (such as the method 200 shown in FIG. 2). The server 150 may also be included in one or more exemplary systems described herein (such as the system 300 shown in FIG. 3). The server 150 may include an internal database to store data. One or more optional external databases 160 may be configured to couple to the server 150 for storage purposes.

Notably, one skilled in the art can recognize that all the figures herein are exemplary. For all the figures, the layout, arrangement and the number of elements depicted are exemplary only. Any number of elements can be used to implement the technology of the embodiments herein. For instance, in FIG. 1, although one computing device 120 is shown, the technology allows for the network 110 to couple to one or more computing devices 120. Likewise, although one network 110 and one server 150 are shown in FIG. 1, one skilled in the art can appreciate that more than one network and/or more than one server can be utilized and still fall within the scope of various embodiments. Also, although FIG. 1 includes dotted lines to show relationships between elements, such relationships are exemplary. For instance, FIG. 1 shows that the video source 130 is coupled to the network 110, and the computing device 120 is coupled to the network 110. However, the various embodiments described herein also encompass any networking environment where one or more video sources 130 are coupled to the computing device 120, and the computing device 120 is coupled to the network 110.

The system 100 of FIG. 1 may be configured such that video is stored locally and then streamed for remote viewing. In this exemplary embodiment, an IP camera and/or a USB camera may provide video to a local personal computer, which stores the video. The local personal computer may provide the functionalities of recognition, local storage, setup, search, view and live streaming. The video may then be streamed to a server (such as the server 150) for a redirected stream to a client (such as a web client, a mobile client, or a desktop client). The client may be a computing device 120.

In an alternative exemplary embodiment, video may be streamed continuously (24 hours a day, 7 days a week) to the server 150. In other words, an IP camera may provide live streaming, which may be uploaded by the server 150. The server 150 may provide the functionalities of search, setup, view, recognition, remote storage, and remote viewing. Then, the server 150 may stream to a client (such as a web client, a mobile client or a desktop client).

In another exemplary embodiment, video from an IP camera and/or USB camera may be cached locally to a local PC. The local PC has the capabilities of live stream and optional local storage. All the video may then be uploaded to a server (such as the server 150). The server 150 may provide the functionalities of search, setup, view, recognition, remote storage, and remote viewing. The server may then stream the video to a client (such as a web client, a mobile client, or a desktop client).

In yet another exemplary embodiment, analytics may be performed locally by the local PC and then triggered events may be uploaded. Analytics refer to recognition and non-recognition components that may be used to identify an object or a motion. An IP camera and/or a USB camera may provide video to a local personal computer. The local personal computer may provide the functionalities of recognition, local storage, setup, search, view and live streaming. The video may then be streamed to a server (such as the server 150). The server has the functionalities of remote storage and remote viewing. The server may then stream triggered events to a client (such as a web client, a mobile client, or a desktop client).

Turning to FIG. 2, an exemplary method 200 for providing video monitoring is shown. The method 200 may include three steps. At step 202, a target is identified. At step 204, a selection of a trigger is received. At step 206, a response is provided based on the recognition of the identified target and the selected trigger from a video. As with all the methods described herein, the steps of method 200 are exemplary and may be combined, omitted, skipped, repeated, and/or modified.

Any aspect of the method 200 may be user-extensible. For example, the target, the trigger, the response, and any combination thereof may be user-extensible. The user may therefore define any aspect of the method 200 to suit his requirements for video monitoring. The feature of user-extensibility allows for this technology to be more robust and more flexible than the existing technology. As will be discussed later herein, the technology described herein can learn to recognize targets. In other words, end users may train the technology to recognize objects that were previously unrecognized or uncategorized using previously known technology.

It should be noted that the method 200 may be viewed as an implemented “if . . . then statement.” For instance, steps 202 and 204 can be viewed as the “if” portion of the statement. In some embodiments, steps 202 and 204 combined may be known as a rule. Rules may be user-extensible, and any portion of the rules may be user-extensible. More details as to the user-extensibility of rules will be discussed later herein. Likewise, step 206 can be viewed as the “then” portion. Step 206 may also be user-extensible, which will also be described herein. More importantly, users may combine targets, triggers and responses in various combinations to achieve customized results.

Still referring to FIG. 2, at step 202, the target is identified by a computing device 120. The target is displayed from a video through a display of the computing device 120. The target may include one of a recognized object, a motion sequence, a state, and any combination thereof. The recognized object may be a person, a pet or a vehicle. As will be discussed later herein, a motion sequence may be a series of actions that are being targeted for identification. A state may be a condition or mode (such as the state of a flooded basement, an open window, or a machine when a belt has fallen off).

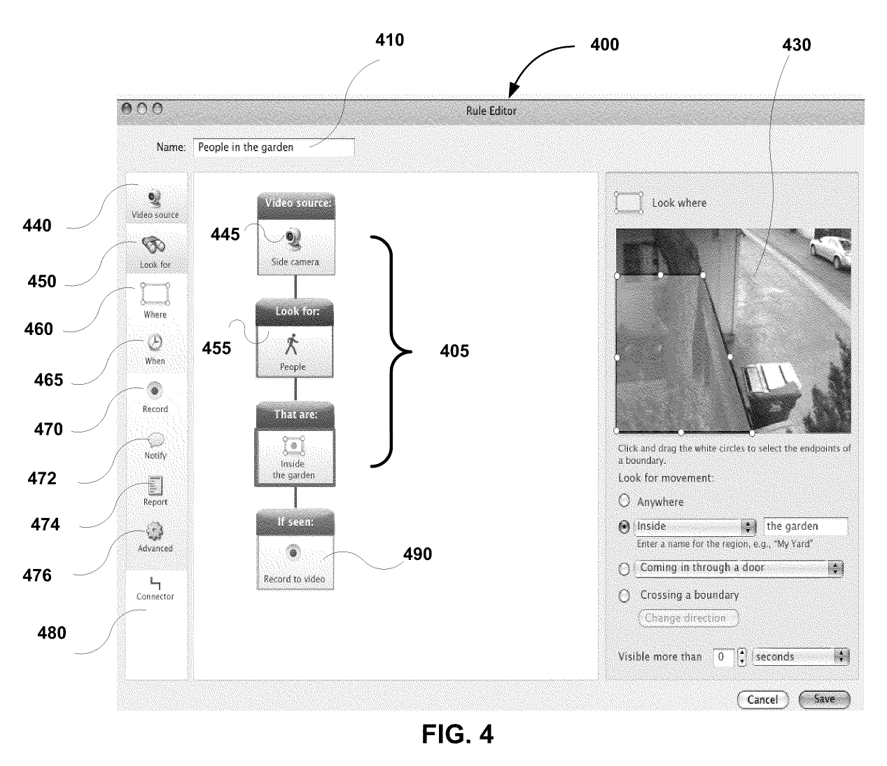

Also, at step 202, identifying the target from a video may include receiving a selection of a predefined object. For instance, preprogrammed icons depicting certain objects (such as a person, a pet or a vehicle) that have already been learned and/or otherwise identified by the software program may be shown to the user through a display of the computing device 120. Thus, the user may select a predefined object (such as a person, a pet or a vehicle) by selecting the icon that best matches the target. Once a user selects an icon of the target, the user can drag and drop the icon onto another portion of the display of the computing device, such that the icon (sometimes referred to as a block) may be rendered on the display. Thus, the icon becomes part of a rule (such as the rule 405 shown in FIG. 4). For instance, if the user selects people as the target, an icon of “Look for: People” (such as the icon 455 of FIG. 4) may be rendered on the display of the computing device. In further embodiments, one or more icons may be added such that the one or more icons may be rendered on the display via a user interface. Exemplary user interfaces include, but are not limited to, “Add” button(s), drop down menu(s), menu command(s), one or more radio button(s), and any combination thereof. Similarly, one or more icons may be removed from the display or modified as rendered on the display, through a user interface.

The technology allows for user-extensibility for defining targets. For instance, a user may “teach” the technology how to recognize new objects by assigning information (such as labels or tags) to clips of video that include the new objects. Thus, a software program may “learn” the differences between categories of pets, such as cats and dogs, or even categories of persons, such as adults, infants, men, and women. Alternatively, at step 202, identifying the target from a video may include recognizing an object based on a pattern. For instance, facial patterns (frowns, smiles, grimaces, smirks, and the like) of a person or a pet may be recognized.

Through such recognition based on a pattern, a category may be established. For instance, a category of various human smiles may be established through the learning process of the software. Likewise, a category of variety of human frowns may be established by the software. Further, a behavior of a target may be recognized. Thus, the software may establish any type of behavior of a target, such as the behavior of a target when the target is resting or fidgeting. The software may be trained to recognize new or previously unknown objects. The software may be programmed to recognize new actions, new behaviors, new states, and/or any changes in actions, behaviors or states. The software may also be programmed to recognize metadata from video and provide the metadata to the user through the display of a computing device 120.

In the case where the target is a motion sequence, the motion sequence may be a series of actions that are being targeted for identification. One example of a motion sequence is the sequence of lifting a rock and tossing the rock through a window. Such a motion sequence may be preprogrammed as a target. However, as described earlier, targets can be user-extensible. Thus, the technology allows for users to extend the set of targets to include targets that were not previously recognized by the program. For instance, in some embodiments, targets can include previously unrecognized motion sequences, such as the motion sequence of kicking a door down. Also, targets may even include visual, audio, and both visual-audio targets. Thus, the software program may be taught to recognize a baby's face versus an adult female's face. The program may be taught to recognize a baby's voice versus an adult female's voice.

At step 204, receiving the selection of the trigger may include receiving a user input of a predefined trigger icon provided by the computing device. The trigger comprises an attribute of the target relating to at least one of a location, a direction, a clock time, a duration, an event, and any combination thereof. A trigger usually is not a visible object, and therefore a trigger is not a target. Triggers may be related to any targets that are within a location or region (such as “inside a garden” or “anywhere” within the scope of the area that is the subject matter of the video). The trigger may be related to any targets that are moving within a certain direction (such as “coming in through a door” or “crossing a boundary”). The trigger may be related to targets that are visible for a given time period (such as “visible for more than 5 seconds” or “visible for more than 5 seconds but less than 10 seconds”). The trigger may be related to targets that are visible at a given clock time (such as “visible at 2:00 pm on Thursdays”). The trigger may be related to targets that coincide with events. An event is an instance when a target is detected (such as “when a baseball flies over the fence and enters the selected region”).

As mentioned previously, step 204 may be user-extensible insofar that the user may define one or more triggers that are to be part of the rule. For instance, the user can select predefined trigger icons, such as icons that say “inside a garden” and “visible>5 seconds.” With such a selection, the attributes of the identified targets include those targets inside of a garden (as depicted in a video) that are also visible for more than 5 seconds. Also, the user is not limited to predefined trigger icons. The user may define his own trigger icons, by teaching the software attributes based on object attribute recognition. In other words, if the software program does not have a predefined trigger icon (such as “having the color red”), the user may teach the software program to learn what constitutes the color red as depicted in one or more videos, and then can define the trigger “having the color red” for later usage in rules.

At step 206, the response may include a recording of the video, a notification, a generation of a report, an alert, a storing of the video on a database associated with the computing device, and any combination thereof. As stated previously, the response may constitute the “then” portion of an “if . . . then statement” such that the response is provided once the “if” condition is satisfied by the rule provided by the user. In other words, if a target has been identified and a trigger selection has been received, then a response based on the recognition of the identified target and the selected trigger may be provided.

A response may include recording one or more videos. The recording may be done by any video recording device, including but not limited, to video camera recorders, media recorders, and security cameras. A response may include a notification, such as a text message to a cell phone, a multimedia message to a cell phone, a generation of an electronic mail message to a user's email account, or an automated phone call notification.

Another type of response may include a generation of a report. A report may be a summary of metadata that is presented to a user for notification or analysis. A report may be printed and/or delivered, such as a security report to authorities, a printed report of activity, and the like. An alert may be a response, which may include a pop-up alert to the user on his or her desktop computer that suspicious activity is occurring in the area that is the subject of a video. An example of such a pop-up alert is provided in U.S. patent application Ser. No. ______ filed on Feb. 9, 2009, titled “Systems and Methods for Video Analysis,” which is hereby incorporated by reference. Further, a response may be the storing of the video onto a database or other storage means associated with the computing device. A response may be a command initiated by the computing device 120.

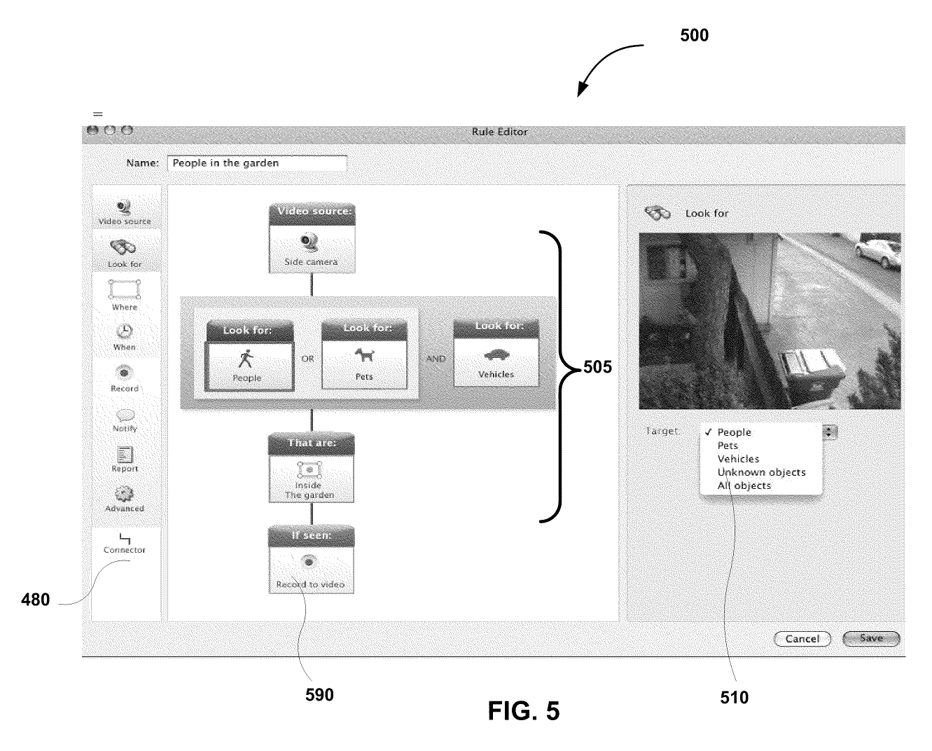

As with all aspects of the method 200, the response is user-extensible. Thus, the user may customize a response or otherwise define a response that is not predefined by the software program. For instance, the user may define a response, such as “turn on my house lights,” and associate the system 100 with one or more lighting features within the user's house. Once the user has defined the response, the user may then select a new response icon and designate the icon as a response that reads: “turn on my house lights.” The response icon that reads “turn on my house lights” can then be selected such that it is linked or connected to a rule (such as the rule 405 of FIG. 5).

The method 200 may include steps that are not shown in FIG. 2. The method 200 may include the step of determining an identification of the target based on a user input to the computing device. The method 200 may include the step of detecting a characteristic of the target to aid in the target identification. Detecting the characteristic of the target may be based on a user input to the computing device.

FIG. 3 is an exemplary system 300 for recognizing targets in a video. The system 300 may includes three modules, namely, a target identification module 310, an interface module 320 and a response module 330. The system 300 can utilize any of the various exemplary methods described herein, including the method 200 (FIG. 2) described earlier herein. It will be appreciated by one skilled in the art that any of the modules shown in the exemplary system 300 may be combined, omitted, or modified, and still fall within the scope of various embodiments.

According to one exemplary embodiment, the target identification module 310 is configured for identifying a target from the video supplied to a computing device 120 (FIG. 1). The interface module 320 is in communication with the target identification module 310. The interface module 320 is configured for receiving a selection of a trigger based on a user input to the computing device. The response module 330 is in communication with the target identification module 310 and the interface module 320. The response module 330 may be configured for providing a response based on recognition of the identified target and the selected trigger from the video.

The system 300 may comprise a processor (not shown) and a computer readable storage medium (not shown). The processor and/or the computer readable storage medium may act as one or more of the three modules (i.e., the target identification module 310, the interface module 320, and the response module 330) of the system 300. It will be appreciated by one of ordinary skill that examples of computer readable storage medium may include discs, memory cards, servers and/or computer discs. Instructions may be retrieved and executed by the processor. Some examples of instructions may include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments.

Turning to FIG. 4, an exemplary screenshot of a rule editor 400 as depicted on a display of a computing device 120 (FIG. 1) is shown. The rule editor 400 is a feature of the technology that allows the user to define one or more aspects of a given rule or query 405. In FIG. 4, a rule name for a given rule (such as a rule name of “People in the garden”) is provided in a name field 410. Preferably, the rule editor 400 allows the user to provide names to the rule 405 that the user defines or otherwise composes.

Still referring to FIG. 4, a plurality of icons may be provided to the user 420. An icon of a video source 440 may be provided. The video source 440 may be displayed with one or more settings, such as the location of the camera (“Video source: Side camera” in FIG. 4). A user may click on the video source icon 440, drag it across to another portion of the display, and drop it in an area of the display. The dragged and dropped icon may then become a selected side camera video source icon 445 (“Video source: Side camera”), which is shown on FIG. 4 as being located near the center of the display. Alternatively, a user may click on the video source icon 440 until a corresponding icon of the selected video source 445 (with a setting, such as the location of the selected video source) is depicted in the rule 405. Alternatively, the user may be provided with one or more video sources 440, and the user can select from those video sources 440. A list of possible video sources (not shown) may appear on the display. Preferably, the list of possible video sources (not shown) may appear on a right portion of the display. Alternatively, as described previously herein, the user may add, remove, or modify one or more icons (such as the video source icon 440) from the display through one or more user interfaces, such as an “Add” button, drop down menu(s), menu command(s), one or more radio button(s), and any combination thereof. Such icons include but are not limited to icons representing triggers, targets, and responses.

Once a video source 440 is selected and displayed as part of the rule 405 (such as the selected side camera video source icon 445), the user can define the target that is to be identified by a computing device. Preferably, the user may select the “Look for” icon 450 on a left portion of the display of the computing device. Then, a selection of preprogrammed targets is provided to the user. The user may select one target (such as “Look for: People” icon 455 as shown in the exemplary rule 405 of FIG. 4).

The user may select one or more triggers. The user may select a trigger via a user input to the computing device 120. A plurality of trigger icons 460 and 465 may be provided to the user for selection. Trigger icons depicted in FIG. 4 are the “Where” icon 460 and the “When” icon 465. If the “Where” icon 460 is selected, then the “Look Where” pane 430 on the right side of the display may be provided to the user. The “Look Where” pane 430 may allow for the user to define the boundaries of a location or region that the user wants movements to be monitored. For instance, the user may define the boundaries of a location by drawing a box, a circle, or any other shape. In FIG. 4, the user has drawn a bounding box around an area that is on the left hand side of a garbage can. The bounding box surrounds an identified target. The bounding box may be used to determine whether a target has entered a region or it serves as a visual clue to the user where the target is in the video. Regions may be named by the user. Likewise, queries or rules may be named by the user. Rules may be processed in real time.

The bounding box may track an identified target. Preferably, the bounding box may track an identified target that has been identified as a result of an application of a rule. The bounding box may resize based on the dimensions of the identified target. The bounding box may move such that it tracks the identified target as the identified target moves in a video. For instance, a clip of a video may be played back, and during playback, the bounding box may surround and/or resize to the dimensions of the identified target. If the identified target moves or otherwise makes an action that causes the dimensions of the identified target to change, the bounding box may resize such that it may surround the identified target while the identified target is shown in the video, regardless of the changing dimensions of the identified target. FIG. 7 of the U.S. patent application Ser. No. ______ filed on Feb. 9, 2009, titled “Systems and Methods for Video Analysis” shows an exemplary bounding box 775. One skilled in the art will appreciate that one or more bounding boxes may be shown to the user to assist in tracking one or more identified targets while a video is played.

Also, the “Look Where” pane 430 may allow the user to select a radio button that defines the location attribute of the identified target as a trigger. The user may select the option that movement “Anywhere” is a trigger. The user may select the option that “inside” a designated region (such as “the garden”) is a trigger. Similarly, the user may select “outside” a designated region. The user may select an option that movement that is “Coming in through a door” is a trigger. The user may select an option that movement that is “Coming out through a door” is a trigger. The user may select an option that movement that is “Walking on part of the ground” (not shown) is a trigger. In other words, the technology may recognize when an object is walking on part of the ground. The technology may recognize movement and/or object in three-dimensional space, even when the movement and/or object is shown on the video in two dimensions. Further, the user may select an option of “crossing a boundary” is a selected trigger.

If the “When” icon 465 is selected, then the “Look When” pane (not shown) on the right side of the display may be provided to the user. The “Look When” pane may allow for the user to define the boundaries of a time period that the user wants movements to be monitored. Movement may be monitored when motion is visible for more than a given number of seconds. Alternatively, movement may be monitored for when motion is visible for less than a given number of seconds. Alternatively, movement may be monitored within a given range of seconds. In other words, a specific time duration may be selected by a user. One skilled in the art that any measurement of time (including, but not limited to, weeks, days, hours, minutes, or seconds) may be utilized. Also, one skilled in the art may appreciate that the user selection may be through any means (including, but not limited to, dropping and dragging icons, checkmarks, selection highlights, radio buttons, text input, and the like).

Still referring to FIG. 4, once a target has been identified and a trigger has been selected, a response may be provided. One or more of a plurality of response icons (such as Record icon 470, Notify icon 472, Report icon 474, and Advanced icon 476) may be selected by the user. As shown in the example provided in FIG. 4, if the Record icon 470 is selected by the user, then “If seen: Record to video” 490 appears on the display of the computing device 120. If read in its entirety, the rule 405 of FIG. 4 entitled “People in the garden” states that using the side camera as a video source, look for people that are inside the garden. If the rule is met, then the response is: “if seen, record to video” (490 of FIG. 4).

If the Notify icon 472 is selected, then a notification may sent to the computing device 120 of the user. A user may select the response of “If seen: Send email” (not shown) as part of the notification. The user may drag and drop a copy of the Notify icon 472 and then connect the Notify icon 472 to the rule 405.

As described earlier, a notification may also be sending a text message to a cell phone, sending a multimedia message to a cell phone, or a notification by an automated phone. If the Report icon 474 is selected, then a generation of a report may be the response. If the Advanced icon 476 is selected, the computer may play a sound to alert the user. Alternatively, the computer may store the video onto a database or other storage means associated with the computing device 120 or upload a video directly to a user-designated URL. The computer may interact with external application interfaces, or it may display custom text and/or graphics.

FIG. 5 shows a screenshot 500 of a display of a computing device 120, where a rule 505 is known as a complex rule. The user may select one or more target(s), one or more trigger(s), and any combination thereof, and may utilize Boolean language (such as “and” and “or”) in association with the selected target(s) and/or trigger(s). For example, FIG. 5 shows Boolean language being used with targets. When the user selects the “Look for” icon 450, the user may be presented with a selection list of possible targets 510, which include People, Pets, Vehicles, Unknown Objects and All Objects. The selection list of possible targets 510 may be a drop down menu. The user may then select the targets he or she wishes to select. In the example provided in FIG. 5, the user selected targets in such a way that the program will identify targets that are either People (“Look for: People”) or Pets (“Look for: Pets”), and the program will also look for targets that are Vehicles (“Look for: Vehicles”). The selection list of possible targets 510 may include an “Add object” or “Add target” option, which the user may select in order to “train” the technology to recognize an object or a target that was previously unknown or not identified by the technology. The user may select a Connector icon 480 to connect one or more icons, in order to determine the logic flow of the rule 505 and/or the logic flow between icons that have been selected.

Another embodiment is where Boolean language is used to apply to multiple triggers for a particular target. For instance, Boolean language may be applied, such that the user has instructed the technology to locate a person “in the garden OR (on the sidewalk AND moving left to right).” With this type of instruction, the technology may locate either persons in the garden or persons that are on the sidewalk who are also moving left to right. As mentioned above, one skilled in the art will recognize that the user may include Boolean language that apply for both one or more targets(s) as well as one or more trigger(s).

A further embodiment is a rule 505 that includes Boolean language that provides a sequence (such as “AND THEN”). For instance, a user may select two or more triggers to occur in a sequence (e.g., “Trigger A” happens AND THEN “Trigger B” happens. Further, one skilled in the art will understand that a rule 505 includes one or more nested rules, as well as one or more rules in a sequence, in a series, or in parallel. Rules may be ordered in a tree structure with multiple branches, with one or more responses coupled to the rules.

As shown in FIG. 5, the user may select the targets by placing checkmarks next to the targets he wishes to designate in the selection list of possible targets 510. However, one skilled in the art can appreciate that the selection of targets can be accomplished by any means of selection, and the selection of targets is not limited to highlighting or placing checkmarks next to selected targets.

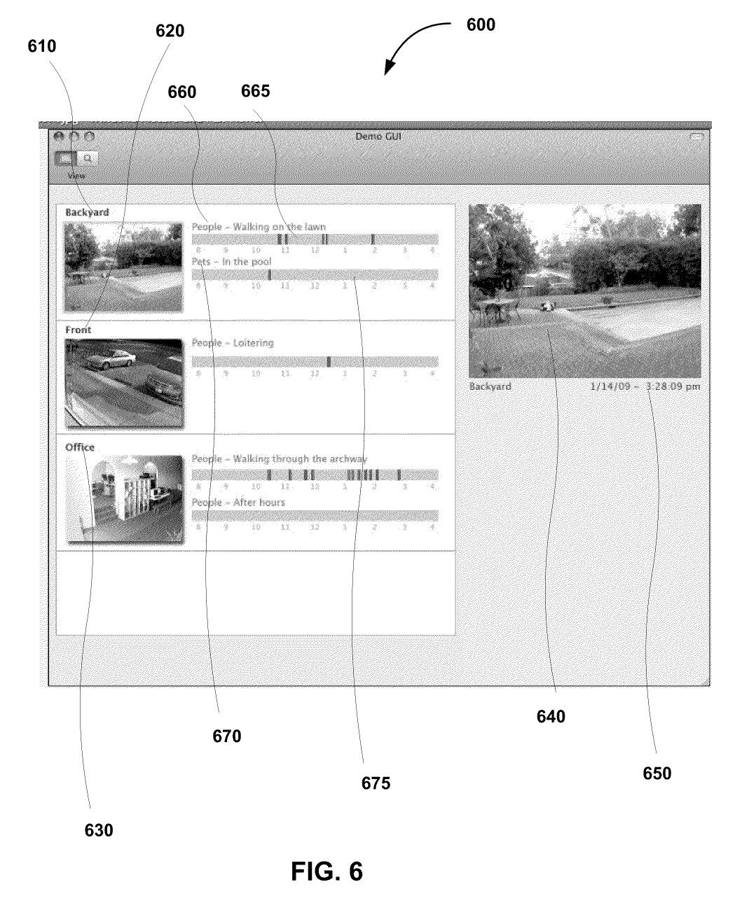

Now referring to FIG. 6, a monitor view 600 of the one or more video sources 130 (FIG. 1) is provided. The monitor view 600 provides an overall glance of one or more video sources 130, in relation with certain timelines of triggered events and rules established by users. Preferably, the monitor view 600 is a live view of a selected camera. The monitor view 600 may provide a live thumbnail of a camera view. The timelines of triggered events may be representations of metadata that are identified and/or extracted from the video by the software program.

In the example provided in FIG. 6, the monitor view 600 includes thumbnail video views of the Backyard 610, Front 620, and Office 630. Further, as depicted in FIG. 6, the thumbnail video view of the Backyard 610 is selected and highlighted on the left side of the display. On the right hand of the display, a larger view 640 of the video that is presented in the thumbnail video view of the Backyard 610 may be provided to the user, along with a time and date stamp 650. Also, the monitor view 600 may provide rules and associated timelines. For instance, the video source 130 located in the Backyard 610 has two rule applications, namely, “People—Walking on the lawn” 660 and “Pets—In the Pool” 670. A first timeline 665 is associated with the rule application “People—Walking on the lawn” 660. Similarly, a second timeline 675 is associated with the rule application “Pets—In the Pool” 670. A rule application may comprise a set of triggered events that meet requirements of a rule, such as “People in the garden” 405 (FIG. 4). The triggered events are identified in part through the use of metadata of the video that is recognized, extracted or otherwise identified by the program.

The first timeline 665 is from 8 am to 4 pm. The first timeline 665 shows five vertical lines. Each vertical line may represent the amount of time in which movement was detected according to the parameters of the rule application “People—Walking on the lawn” 660. In other words, there were five times during the time period of 8 am to 4 pm in which movement was detected that is likely to be people walking on the lawn. The second timeline 675 is also from 8 am to 4 pm. The second timeline 675 shows only one vertical line, which means that in one time period (around 10:30 am), movement was detected according to the parameters of the rule application “Pets—In the Pool” 670. According to FIG. 6, around 10:30 am, movement was detected that is likely to be one or more pets being in the pool.

As mentioned previously, the technology mentioned herein is not limited to video. External data sources, such as web-based data sources, may be utilized in the system 100 of FIG. 1. Such external data sources may be used either in conjunction with or in place of the one or more video sources 130 in the system 100 of FIG. 1. For instance, the technology encompasses embodiments that include data from the Internet, such as a news feed. Thus, the technology allows for a rule and response to be established if certain data is received. An example of this type of rule and response is: “If the weather that is presented by the Internet news channel forecasts rain, then turn off the sprinkler system.” The system 100 of FIG. 1 allows for such a rule and response to be defined by a user and then followed by the system 100. Preferably, a rule includes a target and a trigger. However, in some embodiments, a rule may include a target, a trigger, a response, and any combination thereof.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

1. A method for providing video monitoring, comprising,
identifying a target by a computing device, the target being displayed from a video through a display of the computing device;
receiving a selection of a trigger via a user input to the computing device; and
providing a response of the computing device, based on recognition of the identified target and the selected trigger from the video.

2. The method of claim 1, wherein one of the target, the trigger, the response, and any combination thereof is user-extensible.

3. The method of claim 1, wherein the target comprises one of a recognized object, a motion sequence, a state, and any combination thereof.

4. The method of claim 1, wherein identifying the target from a video further comprises receiving a selection of a predefined object.

5. The method of claim 1, wherein identifying the target from a video further comprises recognizing an object based on a pattern.

6. The method of claim 2, wherein the recognized object is at least one of a person, a pet and a vehicle.

7. The method of claim 1, wherein receiving the selection of the trigger comprises receiving a user input of a predefined trigger icon provided by the computing device.

8. The method of claim 7, wherein the trigger comprises an attribute of the target relating to at least one of a location, a direction, a clock time, a duration, an event, and any combination thereof.

9. The method of claim 1, wherein the video comprises one of a video feed, a video scene, a captured video, a video clip, a video recording, and any combination thereof.

10. The method of claim 1, wherein the video is provided by at least one of a camera, a fixed security camera, a video camera, a webcam, an IP camera and any combination thereof.

11. The method of claim 1, wherein the response is one of a recording of the video, a notification, a generation of a report, an alert, a storing of the video on a database associated with the computing device, and any combination thereof.

12. The method of claim 1, wherein the computing device is one of a computer, a laptop computer, a desktop computer, a mobile communications device, a personal digital assistant, a video player, an entertainment device, and any combination thereof.

13. The method of claim 1, further comprising determining an identification of the target based on a user input to the computing device.

14. The method of claim 1, further comprising detecting a characteristic of the target to aid in the target identification.

15. The method of claim 14, wherein detecting the characteristic of the target is based on a user input to the computing device.

16. A computer readable storage medium having instructions for execution by the processor which causes the processor to provide a response;
wherein the processor is coupled to the computer readable storage medium, the processor executing the instructions on the computer readable storage medium to:
identify a target by a computing device, the target being displayed from a video through a display of the computing device;
receive a selection of a trigger via a user input to the computing device; and
provide a response of the computing device, based on recognition of the identified target and the selected trigger from the video.

17. The computer readable storage medium of claim 16, wherein one of the target, the trigger, the response, and any combination thereof is user-extensible.

18. The computer readable storage medium of claim 16, wherein the target comprises one of a recognized object, a motion sequence, a state, and any combination thereof.

19. The computer readable storage medium of claim 16, wherein the instruction to identify the target from the video further comprises an instruction to recognize an object based on a pattern.

20. The computer readable storage medium of claim 16, wherein the trigger comprises an attribute of the target relating to at least one of a location, a direction, a clock time, a duration, an event, and any combination thereof.

21. The computer readable storage medium of claim 16, wherein the response is one of a recording of the video, a notification, a generation of a report, an alert, a storing of the video on a database associated with the computing device, and any combination thereof.

21. The computer readable storage medium of claim 16, wherein the computing device is one of a computer, a laptop computer, a desktop computer, a mobile communications device, a personal digital assistant, a video player, an entertainment device, and any combination thereof.

22. The computer readable storage medium of claim 16, wherein the instructions further comprise an instruction to determine an identification of the target based on a user input to the computing device.

23. The computer readable storage medium of claim 16, wherein the instructions further comprise an instruction to detect a characteristic of the target to aid in the target identification.

24. The computer readable storage medium of claim 23, wherein the instruction to detect the characteristic of the target is based on a user input to the computing device.

26. A system for recognizing targets from a video, comprising,
a target identification module configured for identifying a target from the video supplied to a computing device;
an interface module in communication with the target identification module, the interface module configured for receiving a selection of a trigger based on a user input to the computing device; and
a response module in communication with the target identification module and the interface module, the response module configured for providing a response based on recognition of the identified target and the selected trigger from the video.

27. The system of claim 26, wherein one of the target, the trigger, the response, and any combination thereof is user-extensible.

28. The system of claim 26, wherein the target identification module further comprises a pattern recognition module configured for recognizing a pattern of the target.

29. The system of claim 26, wherein the target identification module further comprises a category recognition module configured for recognizing a category of the target.

30. The system of claim 26, wherein the target identification module further comprises a behavior recognition module configured for recognizing a behavior of the target.

31. A system for providing video monitoring, comprising:
a processor;
a computer readable storage medium having instructions for execution by the processor which causes the processor to provide a response;
wherein the processor is coupled to the computer readable storage medium, the processor executing the instructions on the computer readable storage medium to:
identify a target;
receive a selection of a trigger; and
provide a response, based on recognition of the identified target and the selected trigger from a video.

32. The system of claim 31, wherein one of the target, the trigger, the response, and any combination thereof is user-extensible.

33. The system of claim 31, wherein identifying the target comprises recognizing an object based on user input to a computing device coupled to the system.

34. The system of claim 31, wherein identifying the target comprises recognizing an object based on a pattern programmed in the computer readable storage medium.

35. The system of claim 31, the system further comprising a module to receive an input from an external data source.

36. The system of claim 35, wherein the external data source includes a web-based data source.
